(19) United States
(12) Patent Application Publication
(10) Pub. No.: US 2011/0071919 A1
(43) Pub. Date: Mar. 24, 2011

(54) GARDEN DESIGN METHOD

(75) Inventor: Helen Spry, Caboolture (AU)

(73) Assignee: Sprywat Pty Ltd as Trustee for Spry Family Trust

(21) Appl. No.: 12/886,948

(22) Filed: Sep. 21, 2010

(30) Foreign Application Priority Data
Sep. 24, 2009 (AU) 2009904650

(51) Int. Cl. G06Q 30/00; G06F 17/50; G06F 15/16; G06F 3/048

(52) U.S. Cl. 705/26.5; 703/1

(57) ABSTRACT

A garden design method is performed using a server computer configured to communicate via the Internet with a remote computer of a customer. The method includes the step of providing queries from the server computer to the remote customer computer which relate to a garden design. One of the queries relates to a type (e.g. shape, theme, etc.) of the garden design. The method further includes the step of obtaining responses to the server computer via the Internet from the remote computer to the queries provided to the customer. At least one garden template based upon the obtained responses is determined by the server computer using software including machine-readable instructions executable by the server computer.

### TECHNICAL FIELD

The present invention generally relates to a garden design method.

### BACKGROUND

The reference to any prior art in this specification is not, and should not be taken as an acknowledgement or any form of suggestion that the prior art forms part of the common general knowledge.

Landscape gardeners can design and landscape gardens according to a customer's requirements. However, many customers cannot afford the full services of a landscape gardener and would prefer to labor themselves to save on costs.

It is an object of the present invention to provide an alternative garden design method which obviates the need to employ a landscape gardener.

### SUMMARY OF THE INVENTION

According to one aspect of the present invention, there is provided a garden design method including the steps of:
providing queries to a customer which relate to a garden design, one of the queries relating to a type of the garden design;
obtaining responses to the queries provided to the customer; and
determining, using computational means, at least one garden template based upon the obtained responses.

The computational means determines a suitable garden template based upon the customer's responses without the need to hire a landscape gardener. The customer can then implement the garden design in accordance with the determined template.

The step of providing queries may involve displaying possible selections in multiple choice format with each selection having an associated radio button. The responses may be obtained responsive to a user selecting respective radio buttons with a mouse.

The query relating to the type of the garden design may relate to the shape of the garden design. The query relating to the type of the garden design may further relate to whether a feature garden or a vegetable garden is required. The query relating to the type of the garden design may further relate to a desired garden theme. The theme may include any one of Japanese, Tropical, Balinese, English, Contemporary, etc.

The queries may further relate to any one or more of the following: the geographical or climatic region in which the garden design is intended, the plant species to be included in the garden design, the sun exposure of the intended location of the garden design, the foliage color of the plants to be included in the garden design, the size of the garden design, and the maximum height of the plants to be used in the garden design.

Subsequent to the step of determining, the method may further involve the step of sending the customer a preview of the at least one garden template.

The method may further involve the step of receiving a selection of one of the previewed templates by the customer.

The method may further involve the step of enabling the customer to purchase the selected garden template. The step of enabling may involve enabling the customer to purchase plants included in the garden template. The step of enabling may involve enabling the customer to purchase features to be included in the garden template.

The method may further include the steps of issuing the customer with a receipt for their purchase and providing access to the purchased garden template.

In one embodiment, the computational means includes a server which provides the queries over the Internet and to a remote computer, the queries being displayed to the customer on the remote computer.

According to another aspect of the present invention, there is provided computational means configured to:
provide queries to a customer's remote computer which relate to a garden design, one of the queries relating to a type of the garden design;
obtain responses to the queries from the customer's remote computer; and
determine at least one garden template based upon the obtained responses.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a block diagram of a garden design system incorporating a web-server according to a preferred embodiment of the present invention;

FIG. 2 is a schematic view of a garden design database of the garden design system of FIG. 1;

FIG. 3 is a flowchart of a garden design method performed by a web-server of the garden design system of FIG. 1;

FIG. 4 is an example web-page 80 showing various climatic regions and for displaying on a remote computer of the garden design system of FIG. 1;

FIG. 5 is an example web-page 80 presenting various queries relating to a triangular garden type and for displaying on a remote computer of the garden design system of FIG. 1;

FIG. 6 is an exemplary triangular garden template which can be determined in accordance with responses to the queries of FIG. 5; and

FIG. 7 shows another exemplary garden template shape.

### DETAILED DESCRIPTION OF PREFERRED EMBODIMENTS

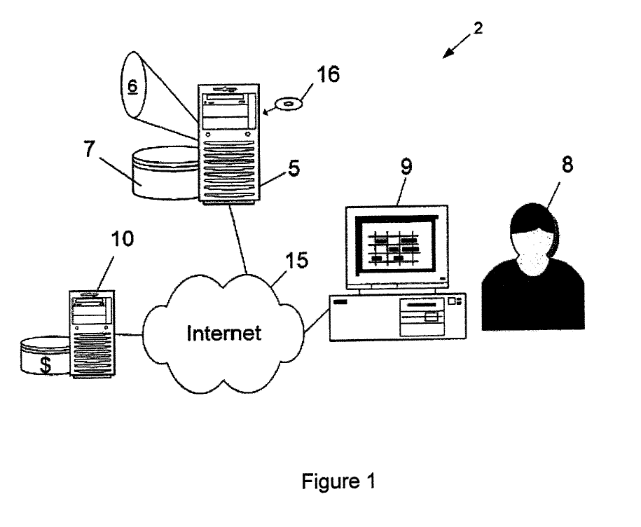

According to an embodiment of the present invention, there is provided an online garden design system 2 incorporating a web-server 5 (i.e. computational means) as shown in FIG. 1. The web-server 5 is configured to provide queries to a remote computer 9 of a customer 8. The queries relate to a desired garden design and one of the queries relates to a type (e.g. shape, feature garden, vegetable garden, etc.) of the garden design. The web-server 5 obtains responses to the queries from the customer's remote computer 9. In turn, the web-server 5 determines at least one suitable garden template based upon the obtained responses from the customer 8, without the need to hire a landscape gardener. The customer 8 can then implement the garden design in accordance with the determined template. The garden design system 2 is described in detail below.

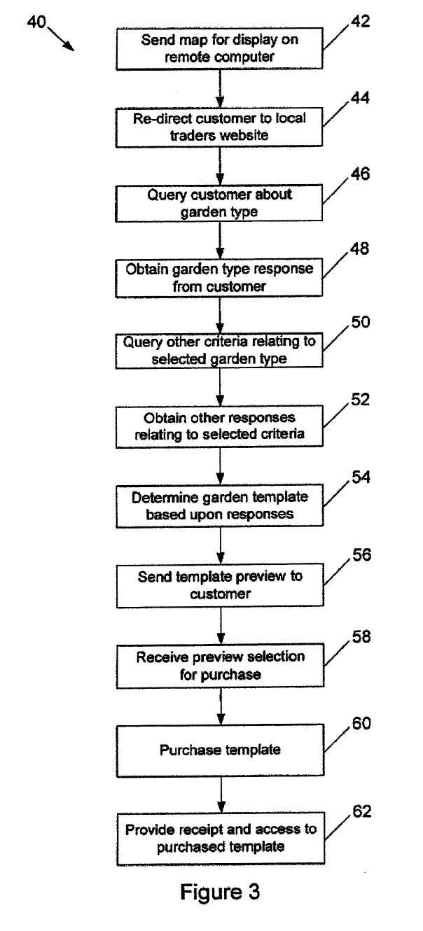

Referring to FIG. 1, there is depicted a block diagram of the garden design system 2. The garden design system 2 is based around a web-server 5 which executes software 6 stored in memory. The software includes machine readable instructions provided on a suitable carrier 16, such as a magnetic or optical disk or in an integrated circuit electronic memory. One or more processors of the server 5 execute the instructions in order to implement the garden design method described in detail below with reference to FIG. 3. It will be realised that the actual coding of the software is straightforward once the method that is described in relation to FIG. 3 is comprehended.

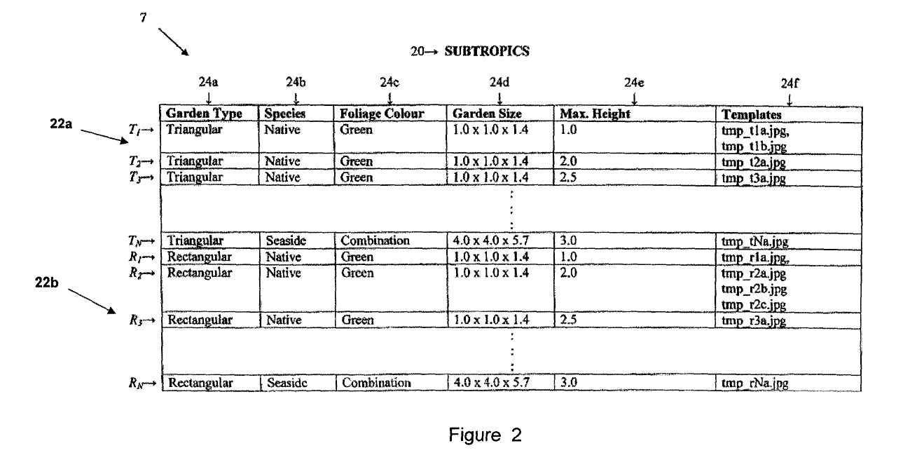

The web-server 5 includes a storage device defining a template database 7 of possible garden templates relating to respective garden designs. Turning to FIG. 2, the template database 7 is divided into geographical or climatic region sections 20 based upon a garden geographic or climatic region (eg. Subtropics) for which the garden design is intended. Each geographical or climatic region section 20 includes garden type subsections 22 (e.g. triangular 22a, rectangular 22b, etc.) based upon the type of garden design. As can be seen in FIG. 2, the triangular subsection 22a includes N triangular database entries T₁-T_{N}.

Each triangular database entry T (or record) includes a plurality of fields 24 including: the type 24a (e.g. shape) of the garden design, the plant species 24b to be included in the garden design, the foliage color 24c of the plants to be included in the garden design, the garden size 24d of the garden design, the maximum height 24e of the plants to be used in the garden design, and a template field 24f associated with at least one electronic garden template (e.g. file tmp_t1a.jpg).

The web-server 5 also hosts a number of websites corresponding to respective climatic regions. A Subtropics based trader (e.g. Garden Designer) can purchase a license to use the software for the climatic region of the Subtropics so that the Subtropics based trader's website can access and utilize the software in the associated climatic region section 20. Similarly, other traders can purchase licenses for their respective climatic regions.

A customer 8 is able to view web-pages produced by the web-server 5 and sent via the Internet 15, by means of the remote computer 9 running suitable web-browser software (e.g. Microsoft Internet Explorer). The customer 8 is provided with data entry forms in the web-pages generated by the web-server 5 in order that the customer may provide responses to garden design queries and payment details. Once the customer 8 has completed query selections and entered payment (e.g. credit card, BPAY, etc.) details to purchase a determined garden template, the web-page generated by web server 5 redirects the web-browser running on remote computer 9 to a financial transaction server 10. The financial transaction server 10 is then able to facilitate the transfer of funds between the customer's and the region's trader's financial institution.

A garden design method 40 performed using the online garden design system 2 is now described with reference to FIG. 3.

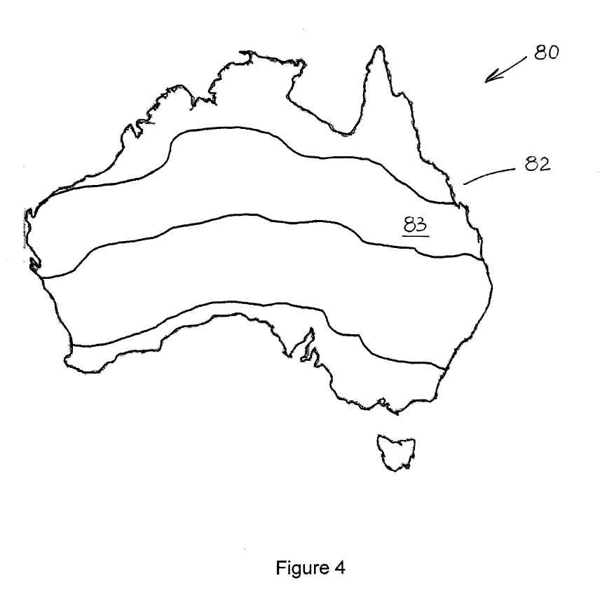

At step 42, a main website hosted on web-server 5 is connected to by customer's remote computer 9. The web-server 5 sends a web-page 80 for display on the remote computer 9 as shown in FIG. 4. The web-page 80 includes a map of Australia 82 whereby each climatic region 83 is interactive and can be selected using a mouse of remote computer 9.

At step 44, the web-server 5 launches a trader's website corresponding to a trader associated with one of the regions selected by the customer 8. For example, the customer 8 can use the mouse of computer system 9 to select the climatic region of the Subtropics 83, and web-server 5 redirects the customer from the main website to the Subtropics region trader's website also hosted on web-server 5.

At step 46, the web-server 5 provides a query to the customer 8 in relation to which type of garden design is desired. The query relating to the type of the garden design requires the customer 8 to nominate the shape of the garden design (e.g. triangular, rectangular, etc.), a feature garden, a vegetable garden or a themed garden.

At step 48, the web-server 5 obtains a response to the garden type query provided to the customer at step 46.

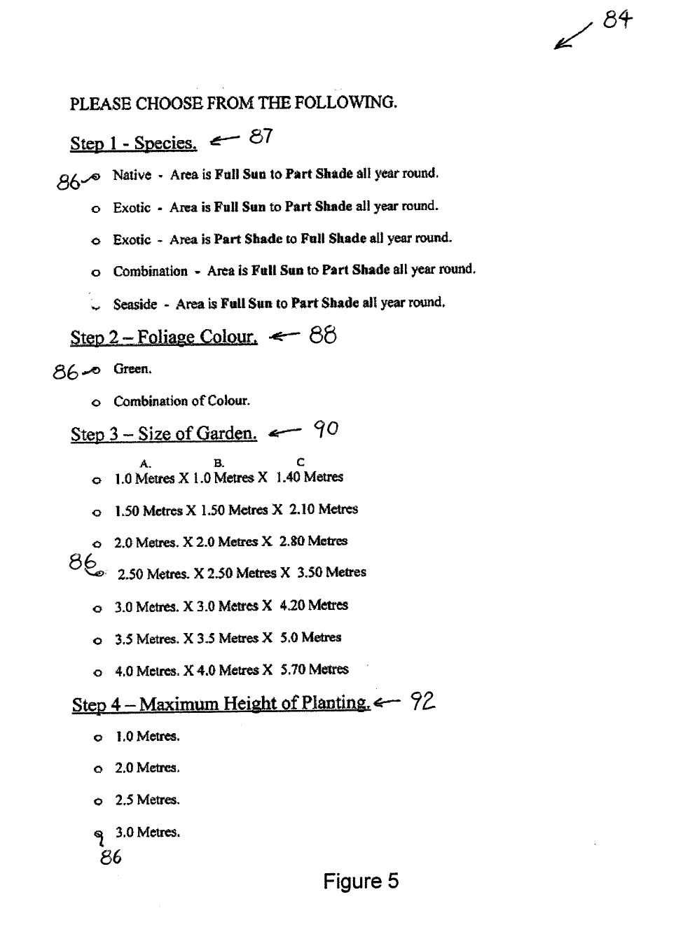

At step 50, the web-server 5 provides further queries to the customer 8 which relate to the selected garden type (e.g. triangular). The web-server 5 sends a web-page 84 for display on the remote computer 9 as shown in FIG. 5 for a triangular garden type. The web-page 84 displays possible garden criteria selections in multiple choice format, with each selection having an associated radio button 86.

As can best be seen in FIG. 5, the further queries relate to the following: the plant species 87 to be included in the garden design including the sun exposure of the intended location of the garden design, the foliage color 88 of the plants to be included in the garden design, the size of the garden design 90, and the maximum height of the plants 92 to be used in the garden design. In one embodiment, further queries relating to a selected garden theme may also be posed.

At step 52, the web-server 5 obtains responses to the further queries provided to the customer at step 50. The responses are obtained subsequent to the customer 8 selecting respective radio buttons 86 with a mouse of the computer 9.

At step 54, the web-server 5 determines at least one garden template based upon the obtained responses at step 52. The database fields 24 relating to the plant species 24b, the foliage color 24c, the garden size 24d, and the maximum height 24e correspond to respective queries relating to plant species 87, foliage color 88, size of the garden design 90, and the maximum height of the plants 92 posed at step 50. The number of possible combinations of selections N entered at step 50 corresponds to the number of triangular database entries T. The web-server 5 can readily determine the electronic garden templates referenced in the template field 24f of the triangular database entry T corresponding to the obtained responses at step 52.

At step 56, the web-server 5 sends a preview of the determined at least one garden template to remote computer 9. The preview includes only partial details of the templates. For example, the plants may be described without actually naming them.

At step 58, the web-server 5 receives a selection of one or more of the previewed templates by the customer 8 whereby the templates are effectively added to a shopping cart for purchase.

At step 60, the web-server 5 enables the customer 8 to purchase the garden template corresponding to the selected preview. The customer 8 is also presented with the option to purchase the plants included in the garden template which will be supplied by an independent local (e.g. Nursery) trader. In addition, the customer 8 can be presented with the option to purchase any features (e.g. statue, fountain, etc.) included in the garden template.

As previously discussed, the web-server 5 sends a payment details web-page to the remote computer 9. Once the customer 8 has entered payment (e.g. credit card, BPAY, etc.) details to purchase a selected garden template into the payment details web-page, the web server 5 redirects the web-browser running on remote computer 9 to a financial transaction server 10. The financial transaction server 10 is then able to facilitate the transfer of funds between the customer's and the local based trader's financial institution.

At step 62, the web-server 5 e-mails the customer a receipt for their template purchase along with a hyperlink to the purchased electronic garden template. The customer 8 can thereby access and print the purchased electronic garden template using the hyperlink for a predetermined length of time, before the web-server 5 withdraws template access.

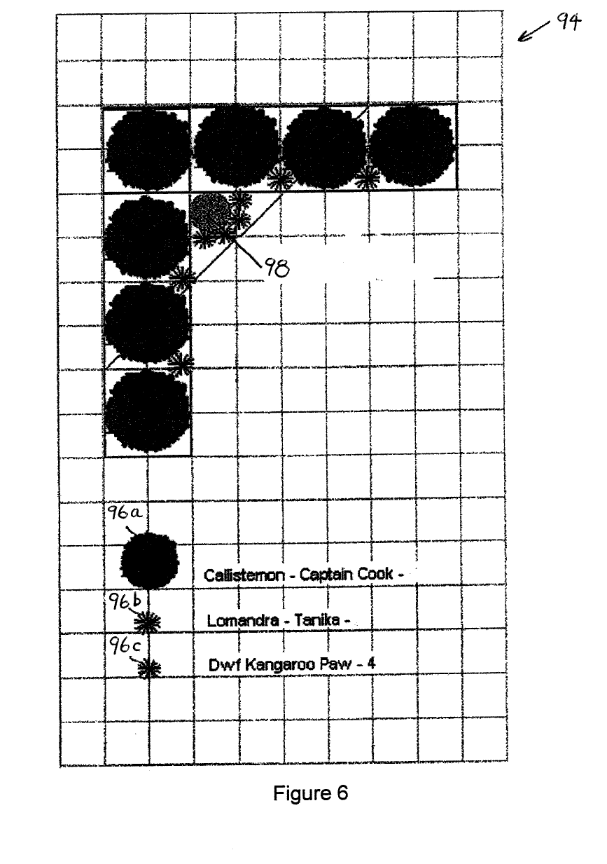

FIG. 6 shows an exemplary triangular garden template 94. The template 94 includes three types of plant 96a, 96b, 96c positioned in a triangular array relative to a grid. A garden feature 98 is also optionally shown.

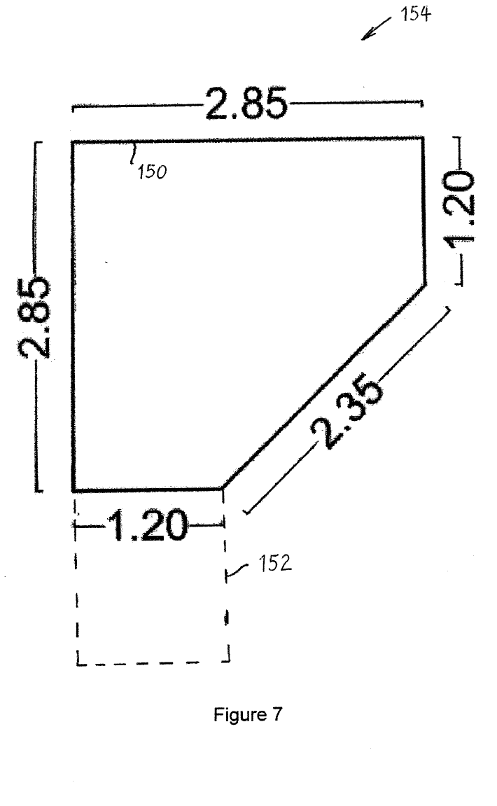

FIG. 7 shows another exemplary garden template 150 (with dimensions in meters) having a shape suitable for locating in a yard corner. In one embodiment, the garden template 150 can connect with another 1.2 m wide rectangular garden template 152 (e.g. at a 1.2 meter edge of template 150) to form a composite template 154 to suit yard space requirements.

A person skilled in the art will appreciate that many embodiments and variations can be made without departing from the ambit of the present invention.

In the preferred embodiment described, the customer 8 was able to select a climatic region (e.g. Subtropics) and thereby be directed to a trader servicing that region. In another embodiment, the customer 8 may instead be able to select a geographic region whereby, for example, Queensland can be selected. In one embodiment, the state of Queensland is divided into tropical north Queensland and Subtropical south Queensland which are subject to different climatic conditions and therefore have different plant selections available in the templates 94.

In one embodiment, the query relating to the type of the garden design at step 46 may relate to a desired garden theme. The theme may include, for example, any one of Japanese, tropical, Balinese, English, and Contemporary themes.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims appropriately interpreted by those skilled in the art.

What is claimed is:

1. A garden design method to be performed using a server computer configured to communicate via the Internet with a remote computer of a customer, the method including the steps of:
providing queries from the server computer via the Internet to the remote computer of the customer, wherein the queries relate to a garden design and include a query relating to a type of the garden design;
obtaining responses to the server computer via the Internet from the computer of the customer to the queries provided to the computer of the customer; and
determining, using software including machine-readable instructions executable by the server computer, at least one garden template based upon the obtained responses.

2. A garden design method as claimed in claim 1, wherein the step of providing queries involves displaying possible selections in multiple choice format.

3. A garden design method as claimed in claim 2, wherein each selection has an associated radio button.

4. A garden design method as claimed in claim 3, wherein the responses are obtained responsive to a user selecting respective radio buttons with a mouse.

5. A garden design method as claimed in claim 1, wherein the query relating to the type of the garden design relates to the shape of the garden design.

6. A garden design method as claimed in claim 1, wherein the query relating to the type of the garden design relates to whether a feature garden or a vegetable garden is required.

7. A garden design method as claimed in claim 1, wherein the query relating to the type of the garden design relates to a desired garden theme.

8. A garden design method as claimed in claim 7, wherein the theme includes any one of Japanese, Tropical, Balinese, English, or Contemporary themes.

9. A garden design method as claimed in claim 1, wherein said queries relate to one or more queries selected from the group consisting of the geographical region in which the garden design is intended, the climatic region in which the garden design is intended, the plant species to be included in the garden design, the sun exposure of the intended location of the garden design, the foliage color of the plants to be included in the garden design, the size of the garden design, and the maximum height of the plants to be used in the garden design.

10. A garden design method as claimed in claim 1 wherein, subsequent to the step of determining, the method further involves the step of sending the customer a preview of the at least one garden template by sending the preview from the server computer to the computer of the customer via the Internet.

11. A garden design method as claimed in claim 10, wherein the method further involves the step of receiving, by the server computer via the Internet, a selection of one of the previewed templates by the customer.

12. A garden design method as claimed in claim 11, further involving the step of configuring the server computer to enable the customer to purchase the selected garden template via the Internet.

13. A garden design method as claimed in claim 12, wherein the step of enabling involves enabling the customer to purchase plants included in the garden template.

14. A garden design method as claimed in claim 12, wherein the step of enabling involves enabling the customer to purchase features to be included in the garden template.

15. A garden design method as claimed in claim 12, further including the step of issuing a receipt to the customer.

16. A garden design method as claimed in claim 12, further including the step of providing access to the purchased garden template.

17. A garden design method as claimed in claim 1, wherein the queries are displayed to the customer on the remote computer.

18. A computer configured to:
provide queries to a customer's remote computer which relate to a garden design, one of the queries relating to a type of the garden design;
obtain responses to the queries from the customer's remote computer; and
determine at least one garden template based upon the obtained responses.
